(19) United States
(12) Patent Application Publication
(10) Pub. No.: US 2019/0093602 A1
(43) Pub. Date: Mar. 28, 2019

(54) ROCKET ENGINE COMBUSTION CHAMBER LINER

(71) Applicant: Shapefidelity, Inc., Huntsville, AL (US)

(72) Inventor: Robert Black, New Market, AL (US)

(73) Assignee: Shapefidelity, Inc., Huntsville, AL (US)

(21) Appl. No.: 16/038,511

(22) Filed: Jul. 18, 2018

Related U.S. Application Data
(60) Provisional application No. 62/562,708, filed on Sep. 25, 2017.

(51) Int. Cl. F02K 9/62; F02K 9/97

(52) U.S. Cl. CPC F02K 9/62; F05D 2230/10; F02K 9/97

(57) ABSTRACT

A rocket engine combustion chamber liner of the present disclosure has a combustion chamber in which fuel and oxygen are ignited thereby generating low-velocity gases. The rocket engine combustion chamber liner further has a throat integral with and in fluid communication with the combustion chamber that generates high-velocity gases from the low-velocity gases received from the combustion chamber. Additionally, the rocket engine combustion chamber has a nozzle integral with and in fluid communication with the throat through which the high-velocity gases are emitted causing thrust for a rocket. The combustion chamber, the throat, and the nozzle have a common outer surface and etched into the outer surface are a plurality of channels wherein the channels have the same width and depth.

### CROSS-REFERENCE TO RELATED APPLICATION

This application claims priority to U.S. Provisional Patent Application Ser. No. 62/562,708 entitled Rocket Engine Combustion Chamber Liner and filed on Sep. 25, 2017, which is incorporated herein by reference.

### BACKGROUND

A rocket comprises a payload, which is any cargo that is being transported in the rocket, e.g., a satellite, a warhead, or human beings. Additionally, the rocket comprises a an oxygen tank that contains any type of fuel, e.g., liquid hydrogen. The rocket further comprises an oxygen tank, which allows a rocket engine to operate in an airless environment. Among other components, the engine comprises a thrust chamber assembly that has a combustion chamber, a throat and a nozzle.

In operation, the engine delivers both fuel and oxygen from the fuel tank and oxygen tank, respectively, to the combustion chamber using pumps. Once the fuel and oxygen are mixed in the combustion chamber, the engine ignites the mixture. When the fuel and oxygen react in the combustion chamber, a tremendous amount of pressure is created, and the gases are moving at low speeds. At the nozzle, the gasses escape moving at very high speeds but low pressure. The throat is where the high-pressure gases with slow velocity in the combustion chamber are converted to the low-pressure gases with high velocity. Working together, the combustion chamber, the throat and the nozzle produce thrust thereby starting the rocket's movement upward into the atmosphere.

Note that the interaction of the fuel and the oxygen releases heat causing the combustion chamber to reach extraordinarily high temperatures. The temperatures are so high that unless the combustion chamber is cooled during operation, the combustion chamber would melt.

One common method of cooling is called regenerative cooling. This is accomplished by flowing high velocity fuel over the outside surface of the chamber to convectively cool the chamber. This is often accomplished by a chamber liner installed within the ti gust chamber assembly.

A typical combustion chamber liner comprises a plurality of channels on an outer surface. These channels are in fluid communication with a manifold around the circumference of the nozzle exit. In this regard, the engine delivers fuel to the manifold, and the manifold injects the fuel through the channels of the combustion finer. The fuel traveling through the channels convectively cools the combustion chamber, and the fuel is then deposited in the combustion chamber for mixing with the oxygen.

FIG. 1 depicts a prior art combustion chamber liner 100. Notably, the combustion chamber liner 100 has a combustion chamber portion 101, a throat portion 102, and a nozzle portion 103. Machined into the outer surface of the chamber liner 100 is a plurality of channels 104. These channels 104 run parallel and in a straight line on an outer surface of the combustion chamber liner 100 from the nozzle exit opening 105 and terminating at or near the combustion chamber portion opening 106 where the combustion liner 100 is in fluid communication with an injector (not shown). Note that the typical combustion chamber liner is made of copper because copper is a good conductor of heat. When fuel, e.g., liquid hydrogen, is pumped through the channels, the copper transmits heat from the combustion into the fuel thereby cooling the chamber.

The chamber liner 100 shown in FIG. 1 is difficult to manufacture. Because of the shape of the chamber liner, the channels starting at the nozzle end 105 are wider and shallower than those channels traversing the throat 102. In this regard, the profiles of the channels in the throat area are narrower and deeper than the portions of the channels that traverse the nozzle portion and the chamber portion. In cutting the channels 104, a different cutter having differing widths and depths must be used on different portions of the channels 104 to ensure that the channels 104 allow constant volume flow of the fuel through the channels 104. Thus, in manufacturing, a different-sized cutter must be used to form the channels 104 on the nozzle portion 103, the chamber portion 101, and the throat portion 102.

### BRIEF DESCRIPTION OF THE DRAWINGS

The disclosure can be better understood referencing the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a prior art combustion chamber used in a rocket.

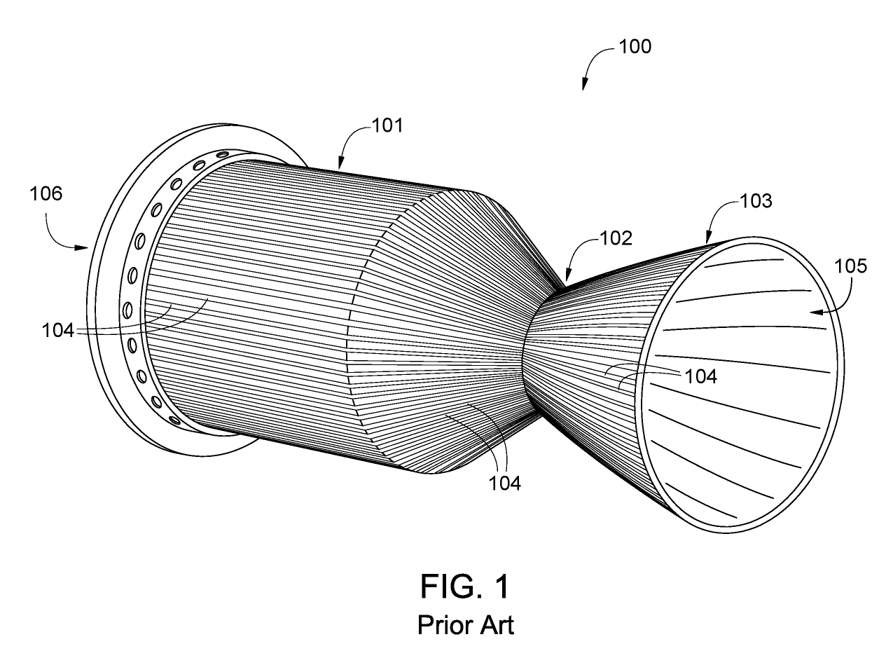

FIG. 2 is a portion of a rocket showing the engine and the combustion chamber.

FIG. 3 is an exemplary combustion chamber in accordance with an embodiment of the present disclosure.

### DETAILED DESCRIPTION

This present disclosure relates to an exemplary combustion chamber liner configured for lining a combustion chamber of a rocket in accordance with an embodiment of the present disclosure. As noted above, the combustion chamber of the rocket is where fuel and oxygen are mixed and burned. The combustion chamber liner allows for regenerative cooling of the combustion chamber. In this regard, the combustion chamber liner of the present disclosure comprises a plurality of helical channels created by a single cutter. Because of the helical characteristic of the channels, the width of the helical channels is constant. The constancy of the width of the channels allows for use of a standard cutter to create the helical channels on the outer sur face of the combustion chamber.

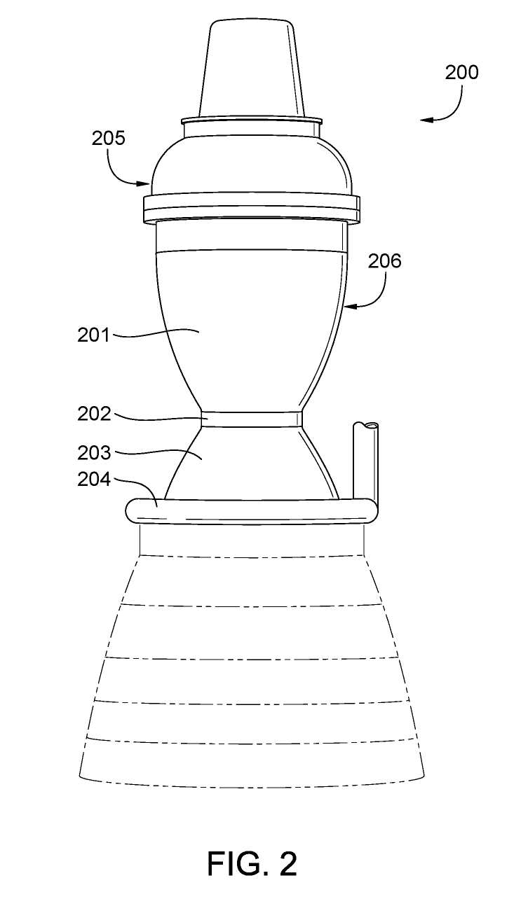

FIG. 2 is a portion of a rocket 200. The portion of the rocket 200 comprises an engine 205, a thrust chamber assembly 206, and a manifold 204. The thrust chamber assembly 206 comprises a combustion chamber 201, a throat 202, and a nozzle 203.

In operation, oxygen and fuel are mixed in the combustion chamber 201 and ignited. The low velocity gasses created from the ignition flow through the throat 102 thereby creating high velocity gasses, which exit the assembly 206 through the nozzle 203. The emission of the high-velocity gases from the nozzle create thrust, which moves the rocket forward.

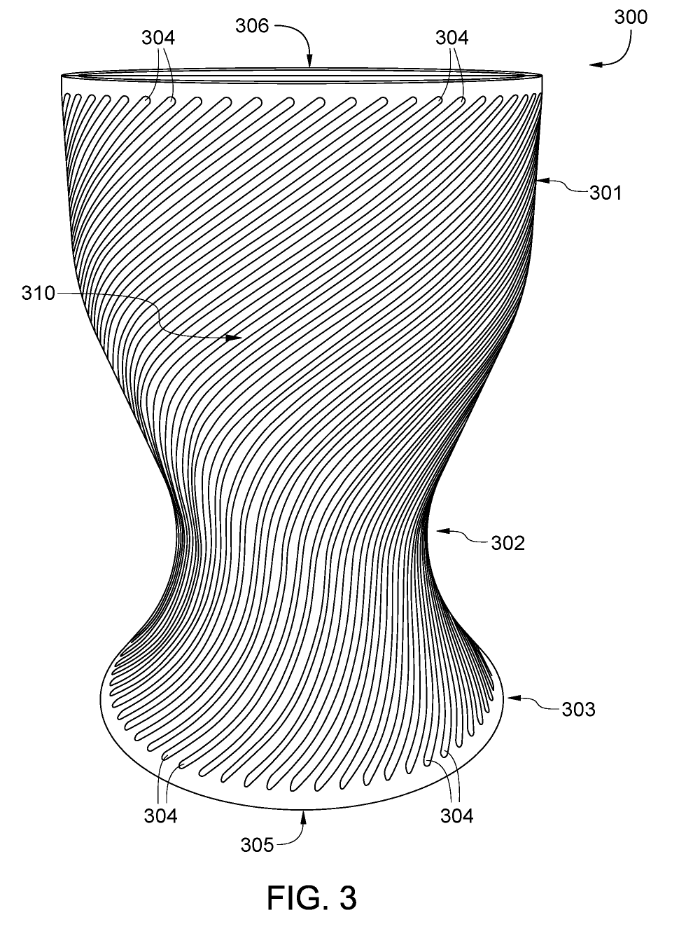

In accordance with an embodiment of the present disclosure, a combustion chamber liner 300 (FIG. 3) is installed inside of the combustion chamber 201. During operation, the engine 205 pumps fuel, e.g., liquid hydrogen, into a manifold 204 in fluid communication with a plurality of channels machined into an outer surface of the liner 300. The fuel is pumped through the channels, which cools the chamber during mixing and ignition. An injector (not shown) receives the fuel from the channels and injects the received fuel into the combustion chamber 201.

FIG. 3 is an exemplary combustion chamber liner 300 in accordance with an embodiment of the present disclosure. The combustion chamber liner 300 is installed within the combustion, chamber assembly 206 (FIG. 2).

The combustion chamber liner 300 comprises a combustion chamber 301, a throat 302, and a nozzle 303. The combustion chamber 301 is howl-shaped and is configured to house fuel and oxygen, which is ignited in the combustion chamber 301. The throat 302 is integral with and in fluid communication with the combustion chamber 301. The throat 302 is configured for receiving low velocity gases created by the ignition of the fuel and oxygen and creating high velocity gases. The nozzle 303 is integral with and in fluid communication with the throat 302. The nozzle 303 is configured for emitting the high-velocity gases to propel or cause thrust for a rocket. Note that the combustion chamber 301, the throat 302, and the nozzle 303 share a common outer surface 310.

Further, a plurality of helical channels 304 are machined into the outer surface 310 of the combustion chamber liner 300. Due to the helical profile of the helical channels 304, each channel 304 has a constant width and depth from the nozzle opening 305 to the chamber opening 306. That is, the width and depth of each of the plurality of helical channels are the same. Because the width and depth of each of the channels 304 are the same, a single cutter may be used to machine the channels 304 into the outer surface 310 of the combustion liner 300. Thus, it is not necessary to change cutter sizes in the process of manufacturing.

During operation, the engine 205 (FIG. 2) pumps fuel, e.g., liquid hydrogen, into a manifold 204 (FIG. 2) in fluid communication with the plurality of channels 304 machined into the outer surface 310 of the liner 300. The fuel is pumped through the channels 304, which cools the chamber during mixing and ignition of the fuel and the oxygen. An injector (not shown) receives the fuel from the channels 304 and injects the received fuel into the combustion chamber 301.

What I claim is:

1. A rocket engine combustion chamber liner, comprising:
a combustion chamber configured for ignition therein of fuel and oxygen generating low-velocity gases;
a throat integral with and in fluid communication with the combustion chamber configured for generating high-velocity gases from the low-velocity gases received from the combustion chamber; and
a nozzle integral with and in fluid communication with the throat through which the high-velocity gases are emitted causing thrust for a rocket,
wherein the combustion chamber, the throat, and the nozzle share a common outer surface comprising a plurality of channels and wherein the channels have the same width and depth.

2. The rocket engine combustion chamber liner of claim 1, wherein each of the plurality of channels is helical-shaped.

3. The rocket engine combustion chamber liner of claim 2, wherein the helical-shaped channels are parallel.

4. The rocket engine combustion liner of claim 1, wherein each of the plurality of channels is etched into the outer surface using a single cutter.

5. A rocket, comprising:
a thrust chamber assembly comprising a combustion chamber, a throat, and a nozzle, the combustion chamber configured for receiving oxygen and fuel;
a rocket engine, in fluid communication with the thrust chamber assembly for delivering the oxygen to the combustion chamber, the rocket engine further configured for delivering fuel to a manifold positioned around an exit opening of the nozzle;
a combustion chamber liner that is positioned within the thrust chamber assembly, the combustion chamber liner having a plurality of channels in fluid communication with the manifold and configured for receiving the fuel, the channels configured for delivering the fuel to the combustion chamber,
wherein the plurality of channels each have the same width and depth.

6. The rocket of claim 5, wherein each of the plurality of channels is helical-shaped.

7. The rocket of claim 6, wherein the helical-shaped channels are parallel.

8. The rocket engine of claim 5, wherein each of the plurality of channels is etched into the outer surface using a single cutter.
